(19) United States
(12) Patent Application Publication
(10) Pub. No.: US 2011/0225986 A1
(43) Pub. Date: Sep. 22, 2011

(54) SYSTEMS AND METHODS FOR GAS SUPPLY AND USAGE

(76) Inventors: Justin Cole Germond, Amherst, NY (US); Kenneth Leroy Burgers, E. Amherst, NY (US); Christos Sarigiannidis, Williamsville, NY (US); Michael Dennis McCain, Williamsville, NY (US); Keith Randall Pace, E. Amherst, NY (US); Heng Zhu, Tonawanda, NY (US); Hisham E. Falah, Buffalo, NY (US)

(21) Appl. No.: 12/728,604

(22) Filed: Mar. 22, 2010

(51) Int. Cl. F17C 9/02; F17C 13/08

(52) U.S. Cl. 62/50.2; 62/53.2

(57) ABSTRACT

This invention relates to gas vaporization and supply system that includes (a) a vessel suitable for holding a bulk quantity of a liquefied gas; (b) at least one heating source positioned on or near the vessel to supply energy to, or remove energy from, the liquefied gas; and (c) a heating source controller adapted to use process variables feedback for dynamically regulating the heating source and maintaining and regulating gas output. The process variables feedback results from cascading sequence control of at least two process variables. The process variables include pressure, temperature, and/or gas output flow rate. This invention also relates to a method for delivery of a gas, e.g., ultra high purity gases, from a liquefied state in a controlled manner to a usage site, e.g., a semiconductor manufacturing facility. This invention provides faster heating system response to fluctuations in customer demand, a longer heater life, and improved reliability.

### FIELD OF THE INVENTION

This invention relates to gas vaporization and supply systems, e.g., ultra high purity gases, and methods for delivery of a gas from a liquefied state in a controlled manner to a usage site, e.g., a semiconductor manufacturing facility. The systems and methods utilize process variables feedback, i.e. temperature, pressure and/or gas output flow rate, for dynamically regulating a heating source and maintaining and regulating gas output to a usage site.

### BACKGROUND OF THE INVENTION

The growth of the electronic industry has created a demand for a supply of large quantities of ultra high purity (UHP) gases. Molecules such as ammonia and silane are used in the electronics industry for different applications. For example, ammonia is one of the primary gases used for metal organic chemical vapor deposition (MOCVD) growth of gallium nitride films. Flow rate requirements for specialty gases such as NH₃ have increased as a result of expansions in 300 mm, LCD and LED fabs. Thus, customers are converting from the conventional cylinder gas delivery systems to Bulk Specialty Gas Supply (BSGS) systems.

In one particular example of such a BSGS system, a low vapor pressure gas such as ammonia is stored in liquid form in a container that has a capacity of several hundred pounds or over ten thousand pounds, e.g., ISO (International Standards Organization) containers, tankers, and the like. The liquefied molecules in the bulk tank containers are heated and vaporized by some heating means at customer sites, and the vaporized gases are delivered at designed flow rate and high purity. The heating power required to vaporize the product depends on the customer demand, e.g., supply flow rate of the gas, and the surrounding environment such as ambient temperature. Supply flow rates required by customer recipes often vary significantly during normal operation.

The purity of the delivered gases is an important factor for BSGS systems. UHP gases must meet stringent specifications for moisture, metal content, particles, and the like. UHP gases typically have impurity concentrations of less than 100 ppb (parts per billion) for any volatile molecule. A particulate concentration (e.g., sizes larger than 0.3 micrometers) is typically less than 1/liter of gas, and metallic impurities are typically less than 10 ppb in atomic units per element.

To ensure reliable performance, it is important to adjust the heating power dynamically to adapt to customer recipes. Failure to adjust the heating power properly may cause disruption in supply pressure, flow rate and purity. In addition, certain surrounding environmental parameters such as ambient temperature can also affect the heating power required for certain customer demands.

Current liquefied gas BSGS heating systems used in the electronics industry operate mainly based upon the feedback from a single process parameter, either temperature or vessel pressure. For example, some systems operate based on heater temperature set points. See, for example, U.S. Pat. No. 6,614,009. The heater temperature set point is typically input directly by an operator. In many cases the temperature set point required is over or underestimated and the system lacks in performance by either constantly turning on and off or failing to meet the required product flow rate. In other systems, the temperature of liquefied gas is derived by indirectly measuring pressure and correlating based upon a vapor pressure/temperature saturation curve algorithm, but the heater temperature is not taken into account in the primary control loop. See, for example, U.S. Pat. No. 6,363,728. In still other systems, the heating power is controlled based on both temperature and pressure feedbacks. See, for example, U.S. Pat. No. 6,581,412.

It is difficult for the above systems to regulate and maintain a minimum heating power and temperature required to accommodate the customer's product withdrawal rate using only temperature and/or pressure as feedback parameters. It is also difficult to automatically start up and ramp up the system by using only temperature and/or pressure as feedback parameters.

Therefore, a need exists for improved reliability of UHP liquefied gas bulk container heating systems. Particularly, a need exists for ensuring reliable heating system response time to fluctuations in customer demand and the surrounding environment, leading to fewer shutdowns of the customer processes and fewer heater change outs.

### SUMMARY OF THE INVENTION

This invention relates in part to a gas vaporization and supply system comprising:
a. a vessel suitable for holding a bulk quantity of a liquefied gas;
b. at least one heating source positioned on or near the vessel to supply energy to, or remove energy from, the liquefied gas; and
c. a heating source controller adapted to use process variables feedback for dynamically regulating said heating source and maintaining and regulating gas output, the process variables feedback resulting from cascading sequence control of at least two process variables.

This invention also relates in part to a method for delivery of a gas from a liquefied state in a controlled manner to a usage site, said method comprising:

(i) providing a vessel holding a bulk quantity of a liquefied gas therein;

(ii) providing at least one heating source positioned on or near the vessel to supply energy to, or remove energy from, the liquefied gas;

(iii) providing a heating source controller adapted to use process variables feedback for dynamically regulating the heating source and maintaining and regulating gas output, the process variables feedback resulting from cascading sequence control of at least two process variables;

(iv) controlling flow of the gas out of the vessel by the heating source controller utilizing the process variables feedback to regulate the heating source; and

(v) delivering the gas to the usage site.

This invention provides a number of advantages. This invention provides a control system that dynamically adjusts the heating power of UHP liquefied gas bulk container heating systems to accommodate the dynamic customer demand pattern and the surrounding environment parameters. This invention provides faster system response to fluctuations in customer demand, a longer heater life, improved reliability and minimum operator intervention.

Compared to the prior art that uses only temperature and/or pressure as the feedback parameter, the control strategy of this invention can react to any fluctuation to customer tool demand more sensitively. In accordance with this invention, the heating power is dynamically regulated using feedbacks from temperature, the vessel pressure, and/or the gas output flow rate measurement. Any changes in the gas output product flow rate will immediately impact the vessel pressure due to mass balance, and then will indirectly impact the temperature of the liquefied gas through vapor/liquid phase equilibrium and heat transfer, which is a slower process, especially for a large vessel such an ISO container. Therefore, by cascading pressure and/or flow rate control with temperature control in accordance with this invention, any change in product withdrawal rate is captured immediately and allows fast response to fluctuations in customer demand. Fast system response ensures uninterrupted operation of customer processes.

This invention also allows the heaters to run at minimal power required during either the ramp-up process or online operation with minimal operator intervention. The two-level and three-level cascading sequence control in this invention respond more sensitively to customer demand, and the power output more closely matches the energy required to vaporize the product at the demanded flow rate. This avoids overheating, e.g., heater burnout, and helps improve heater lifetime and reliability, as the heater life typically decreases if running at higher power. Another advantage from not overheating the tank is to avoid hot spots on the tank and nucleate boiling, which could increase the moisture impurity in the vapor stream.

Another unique feature of this invention is the capability to automatically start and ramp up to full rate, which is made possible by the ability to determine the minimal power required during a dynamic change in customer demand (e.g., starting up or ramping up) using the two-level or three-level cascading sequence control. Due to the minimum operator intervention, a plant rate controller is put in place to manipulate the system temperature, pressure, and flow to increase the flow from its initial state to up to 100% of the customer full flow rate. Since the prior art does not have the same ability to accurately respond to customer demand, more operator intervention may be needed, which increases the possibility of overadjusting or underadjusting the heating power.

The improved system reliability leads to fewer shutdowns of the customer processes and fewer heater change outs, e.g., fewer heater burnouts. This invention is superior to existing control strategies on BSGS systems in providing the minimal power required during dynamic changes in customer demand. This reduces the process costs for customers by reducing the possibility for system shutdown due to insufficient vapor product supply. Additionally, as this invention can alleviate heater degradation by running the heaters at the lowest power required, the cost of ownership of BSGS for customers is also reduced.

### BRIEF DESCRIPTION OF THE DRAWINGS

FIG. 1 is a schematic representation of an example of a heating source controller useful in the gas vaporization and supply system of this invention.

### DETAILED DESCRIPTION OF THE INVENTION

As used herein, ultra-high purity (UHP) means a gas or liquid having less than about 100 parts per billion, preferably less than about 50 parts per billion, and more preferably less than about 10 parts per billion, of molecular impurities, and having less than about 1000 parts per trillion, preferably less than about 500 parts per trillion, and more preferably less than about 10 parts per trillion, of metallic impurities. Most preferably, UHP gases and liquids have less than about 10 parts per billion of molecular impurities and less than about 10 parts per trillion of metallic impurities.

As indicated above, this invention relates in part to a gas vaporization and supply system comprising:

(a) a vessel suitable for holding a bulk quantity of a liquefied gas;

(b) at least one heating source positioned on or near the vessel to supply energy to, or remove energy from, the liquefied gas; and

(c) a heating source controller adapted to use process variables feedback for dynamically regulating said heating source and maintaining and regulating gas output, the process variables feedback resulting from cascading sequence control of at least two process variables.

This invention provides reliable control of UHP liquefied gas bulk container heating systems via cascading sequence control with two or three feedback levels, i.e., temperature, pressure, and/or gas output flow rate. The basic principles of cascading sequence control are essentially the same for both two and three feedback variables. This invention improves system response time to fluctuations in customer demand and the surrounding environment. It also optimizes the heater reliability by minimizing the heater temperature required to maintain uninterrupted gas supply. The heating source is dynamically adjusted to provide just enough power to vaporize the liquefied gas at the flow rate required by customers.

As used herein, “dynamically” and “dynamic” mean continuously or continuous. For example, “dynamically adjusting” or “dynamically regulating” mean continuously adjusting or regulating a heating source to provide just enough power to vaporize a liquefied gas at the flow rate required by customers. The dynamic adjusting and/or regulating is executed by cascading sequence control using feedbacks from temperature, the vessel pressure, and/or the gas output flow rate measurement. Any changes in the gas output product flow rate will immediately impact the vessel pressure due to mass balance, and then will indirectly impact the temperature of the liquefied gas through vapor/liquid phase equilibrium and heat transfer, which is a slower process, especially for a large vessel such an ISO container. Therefore, by cascading pressure and/or flow rate control with temperature control in accordance with this invention, any change in product withdrawal rate is captured immediately and allows fast response to fluctuations in customer demand. Such a fast system response ensures uninterrupted operation of customer processes.

During online operation, the heating power is dynamically adjusted via cascading sequence control with two or three feedback levels. The first level of control is based on temperature, the second level is based on vessel pressure, and the third level is based on the gas delivery flow rate. By cascading sequence control, it is meant that the output of a primary controller is used to manipulate the set point of a secondary controller. For example, a set point is set by the operator for a primary controller, the primary controller calculates its output based the set point and its process variable, and the output from the primary controller sets the set point of a secondary controller. In another example, there can be two primary controllers (“A” and “B”), each controlling a different process variable, with their respective set points set by the operator. The output from A and B are compared and based on certain criteria, only one of the outputs is selected to set the set point of a secondary controller. The cascading sequence control utilized in this invention provides faster system response to fluctuations in customer demand, a longer heater life (e.g., fewer heater burnouts), improved reliability and minimum operator intervention. As used herein, “online” operation refers to the operation of a gas vaporization and supply system in which gas is flowing from a vessel to a usage site.

In accordance with this invention, the heating power is dynamically adjusted via cascading sequence control with two or three feedback levels (temperature, pressure and gas output product flow rate). At least one of empirical data and one or more algorithms are provided that relate the heating power adjustment to the feedback parameters. By using two or three feedback levels of control, the heating power is dynamically adjusted to provide just enough power to vaporize the product at the flow rate required by customers, and therefore the heater temperature can be minimized. Temperature control, pressure control, and gas outlet flow rate control are accomplished through the use of a feedback control scheme.

In an embodiment, the heating power of a heater is controlled via cascade sequence control using temperature and pressure of a heated vessel that contains liquefied gas. A temperature controller such as a proportional-integral-derivative (PID) controller adjusts the heating power to minimize the difference between a temperature set point and a temperature feedback signal, for example, the heater temperature measured by a thermocouple. The temperature controller is in cascade relation to a pressure controller, which takes a vessel pressure feedback signal and calculates an output in the form of a temperature set point for the temperature controller based on the difference between the vessel pressure and a predetermined pressure set point. The heating power is adjusted this way so that the vessel pressure can be maintained at the predetermined pressure set point.

In the case of online operational two level cascade control, e.g., temperature and pressure, the temperature set point is automatically adjusted by the pressure controller and does not need operator input. The operator only needs to set the pressure set point, which is determined by the customer requirement and the pressure drop of the vapor across the delivery line between the gas supply system and the point of use. For example, if the customer requires 130 psig of pressure at the point of use, and the pressure drop of the vapor across the delivery line is about 5 psig, a pressure set point of 150 psig can be used. Although a set point of 135 psig will be sufficient, it is desirable to have a higher pressure upstream and regulate it down at the point of use.

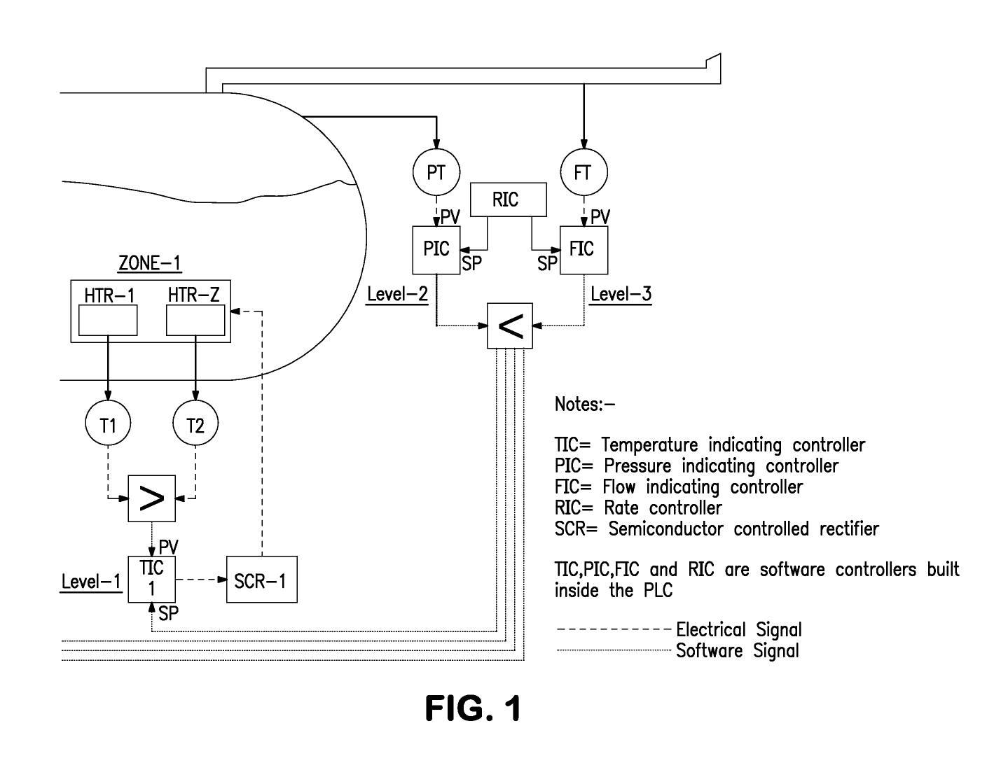

In the case of online operational three level cascade control, e.g., temperature, pressure and flow rate, the temperature set point also does not require operator input. The pressure set point is determined the same way described above for two level cascade control. The flow set point may or may not need operator input. For example, in the FIG. 1 embodiment described below in which, as customer demand changes, the flow controller modulates its output signal, which is continuously compared to the container pressure controller output signal, the operator can set the flow set point as the average flow rate required by the customer. In another embodiment described below in which the FIC is engaged only for a surge in customer demand, flow set point is not needed.

To insure stable and uninterrupted operation, it is desirable to maintain the pressure of the vapor phase in the container (supply pressure) at a certain value. The supply pressure depends on the balance between the vaporization of the liquid phase and the vapor withdrawal. The usage pattern of the gases from BSGS systems usually demands varying vapor withdrawal rates depending on customer recipes and processes. Since the vaporization rate depends on the heating power, the power output and the vapor withdrawal must be aligned in order to maintain a steady pressure in the container. When the vaporization rate corresponding to a certain power output is equal to the vapor withdrawal rate, the pressure can be maintained and the vapor withdrawal rate under this condition is called sustainable flow rate.

However, when the vapor withdrawal rate is increased and the power output is keep constant, the vaporization cannot keep up with the vapor withdrawal and the supply pressure will decrease, and vise versa. The rate of the pressure change reflects the extent of imbalance between the vaporization/power output and the vapor withdrawal rate. Therefore, by adjusting the power output according to the rate of pressure change and/or the vapor withdrawal rate using one of empirical data and one or more algorithms, the supply pressure can be maintained at a desired value and the system can run in a stable manner.

The control logic is shown in FIG. 1 is for a heating source controller useful in the gas vaporization and supply system of this invention. During operation of the system depicted in FIG. 1, the heating power is adjusted via cascading sequence control with three levels. The first level of control is based on temperature, the second level is based on vessel pressure, and the third level is based on the gas delivery flow rate. The first level of control (TIC 1 and SCR-1) adjusts the heating power to maintain the temperature on the heating elements at a certain set point. The second level of control (PIC) senses any change in the vessel pressure due to fluctuation in customer demand and/or surrounding environment such as ambient temperature, and adjusts the temperature set point dynamically based on empirical data or a certain preset algorithm. The third level of control (FIC) involves a product flow controller, which senses the flow rate to the customer and determines a new temperature set point based on the measured flow rate.

In an embodiment, the FIC is engaged only for a surge in customer demand, i.e., when the flow rate demanded by the customer exceeds the rated normal flow capacity for a relatively short period of time. In this case, a flow meter measures the customer flow rate over a period of time, and the FIC increases the pressure set point of the PIC by a certain amount calculated from the magnitude of deviation of the measured average flow rate during the period of time against the rated normal flow capacity. For example, the increase in the set point of the PIC can be proportional to the deviation of the measured flow rate against the rated normal flow capacity. Engaging the FIC in this way helps increase the heating power output and thus maintain vessel pressure during temporary surge demand, which can reduce supply system shutdowns. In this embodiment, TIC, PIC and FIC can use standard Proportional-Integral-Derivative (PID) controllers. A rate controller (“MC”) is used when all three levels of the cascade control are enabled, and the MC manipulates the set points of the PIC and FIC.

An alternative method can be used to help minimize the heater power while maintaining flow. As the customer demand changes, the flow controller modulates its output signal, which is continuously compared to the container pressure controller output signal. The two signals are then compared and the lower value of the two signals will then dictate the amount of heat needed to compensate for the customer demand fluctuations. This is done by adjusting the temperature controller set point.

Other than using the standard PID controllers to achieve the three levels of control, one or more alternative control algorithms/mechanisms can be applied to this invention.

Referring to FIG. 1, cascading sequence control is shown by applying three levels (temperature, pressure and gas delivery flow rate) of control to adjust the power of heaters (HTR-1 and HTR-2) applied on an ISO container containing liquefied gas. In this case, the primary controller is either a pressure controller (“PIC”) or a flow rate controller (“FIC”), and the secondary controller is a temperature controller (“TIC”). The operator can set the set points of both PIC and FIC, which calculate their respective outputs. The outputs from PIC and FIC are compared and the smaller output is used to set the set point of TIC.

Referring to FIG. 1, one of the multiple heating zones (in this case “zone 1”) has two heaters, each of which measures the temperature in its heating area, T1 and T2. The two heaters in the same zone share one PID controller (“TIC 1”). The greater of T1 and T2 feeds into TIC 1 as the process variable. Using the greater of T1 and T2 as the process variable for TIC 1 ensures that in case the heating power is not evenly dissipated from the two heaters of the same zone, the heater that has a higher temperature in its heating area is not overheated, thereby avoiding heater burnout.

The major percentage of installed power of the bulk container is only really required during the initial container pressurization and warm-up just prior to bringing the container online. Once the container is online only a fraction of the installed power will be required to maintain the user's sustainable flow rate requirement. Additional power will be needed at times due to fluctuations in ambient temperature and during peak flow rates. During this situation where additional power is needed the system controller will sense the decrease in container pressure and incrementally increase the temperature set point just enough to achieve set point. Once the conditions have stabilized, the system controller will automatically re-adjust and decrease the heater temperature set point. This cycle will continue until the container is depleted based upon a low level and low weight set point where an automatic switchover to a backup supply will occur.

When a new vessel of liquefied gas arrives at the customer site, the vessel pressure is the equilibrium pressure of the gas at ambient temperature, which is usually lower than the pressure required to deliver vapor to the point of use. There is preferably an initial start up process during which the vessel builds pressure through heating. Initial start up can be achieved with two level cascade sequence control, i.e., temperature and pressure. The temperature controller set point does not require operator input as described above for online operational set points. The pressure controller set point is set at the same value as what is used in online operation, so that the vessel is warmed up to reach operational pressure at the end of the start up.

During start up, first a target tank pressure is set according to a number that is higher than the customer pressure requirement at the point of use plus the pressure drop between the container and the point of use. For example, if the customer's tool requires NH₃ feed of 80 psig, and the pressure drop of the NH₃ at the required flow rate from the container to the point of use is 20 psig, the target tank pressure during start up can be set anywhere higher than 100 psig. In this example, a target tank pressure higher than the minimal (100 psig in this example) would improve reliability at the expense of higher power consumption. Once the target tank pressure is set, system start up can be either controlled manually or automatically using two level cascade sequence control, i.e., temperature and pressure.

When using manual start up, the heating power can be manually set to a fixed percent of the installed power or adjusted manually over the start up period. The container is heated until the pressure reaches the target tank pressure. When using two level cascade sequence control for automatic start up, the operator can set the pressure set point at the target tank pressure, and the system will automatically adjust the heating power and raise the tank pressure to the target. For start up/warm up in accordance with this invention, a two level cascade sequence control is used.

This invention has the capability to automatically start and ramp up to full rate, which is made possible by the ability to determine the minimal power required during a dynamic change in customer demand (e.g., starting up or ramping up) using the two-level or three-level cascading sequence control. Due to the minimum operator intervention, a plant rate controller is put in place to manipulate the system temperature, pressure, and flow to increase the flow from its initial state to up to 100% of the customer full flow rate. The prior art does not have the same ability to accurately respond to customer demand, thus more operator intervention may be needed, which increases the possibility of overadjusting or underadjusting the heating power.

This invention also allows the heaters to run at minimal power required during either the ramp-up process or online operation with minimal operator intervention. The two-level and three-level cascade sequence control used in this invention respond more sensitively to customer demand, and the power output more closely matches the energy required to vaporize the product at the demanded flow rate. This avoids overheating and helps improve heater lifetime and reliability, as the heater life typically decreases if running at higher power. Another advantage from not overheating the tank is to avoid hot spots on the tank and nucleate boiling, which could increase the moisture impurity in the vapor stream.

The heating source useful in this invention can be any conventional heating source for gas containers. Illustrative heating sources include, for example a plurality of heating elements positioned on the vessel to supply energy into the liquefied gas; a ceramic heater positioned on or near the vessel to supply energy into the liquefied gas; a heating jacket positioned on the vessel to supply energy into the liquefied gas; or a heat exchanger positioned on or near the vessel to supply energy to or remove energy from the liquefied gas. With regard to the plurality of heating elements on the vessel, they can be divided into a plurality of heating zones, each heating zone having at least one heating element. Also, programmable logic controller can stagger activation of the heating elements.

In contrast to the prior art that uses only temperature and/or pressure as the feedback parameter, the control strategy of this invention can react to any fluctuation to customer tool demand more sensitively using feedbacks from temperature, the vessel pressure, and/or the gas output flow rate measurement. The disclosures of U.S. Pat. Nos. 6,614,009, 6,363,728 and 6,581,412 are incorporated herein by reference.

As indicated above, this invention also relates in part to a method for delivery of a gas from a liquefied state in a controlled manner to a usage site, said method comprising:

(i) providing a vessel holding a bulk quantity of a liquefied gas therein;

(ii) providing at least one heating source positioned on or near the vessel to supply energy to, or remove energy from, the liquefied gas;

(iii) providing a heating source controller adapted to use process variables feedback for regulating the heating source and maintaining and regulating gas output, the process variables feedback resulting from cascading sequence control of at least two process variables;

(iv) controlling flow of the gas out of the vessel by the heating source controller utilizing the process variables feedback to regulate the heating source; and

(v) delivering the gas to the usage site.

The vessel useful in this invention can be any bulk container suitable for storing and delivering ultra high purity gas such as an ISO container, a tube trailer or a tanker. Other suitable bulk containers include ton containers and drums. As used herein, “bulk container(s)” mean containers that hold a bulk quantity of a liquefied gas, that is containers having a water capacity of at least about 450 liters. The vessel can be constructed from a material such as type 316 stainless steel, Hastelloy, nickel or a coated metal that is non-reactive with the ultra high purity gas and can withstand both a vacuum and high pressures. The vessel can further include a conduit having a first end connected to the vessel and a second end disposed to deliver the liquefied gas, substantially in gaseous form, to a usage site. The ultra-high purity gas can be passed through a filtration apparatus prior to being delivered to the usage site.

The liquefied gas is preferably an ultra high purity gas. However, the liquefied gas can be other than an ultra high purity gas. For example, with ammonia, it may be desired to use a lower grade because the end user may have a point-of-use purifier downstream of BSGS ammonia system. Illustrative liquefied gases include, for example, ammonia, hydrogen chloride, hydrogen bromine, chlorine, perfluoropropane, and the like.

This invention provides a number of advantages. This invention describes methods and systems for reliable UHP gas supply and maintaining dedicated onsite inventory. Specifically, the invention employs one or more ISO containers whereby vaporized UHP gas can be reliably supplied to a usage site, e.g., a semiconductor manufacturing facility.

During normal operation, the heating power is adjusted via cascading sequence control with three feedback levels. The first level of control is based on temperature, the second level is based on vessel pressure, and the third level is based on the gas delivery flow rate.

This invention involves a method for ensuring reliable supply of UHP gas to customers. In an embodiment, the supply method involves direct shipment and maintenance of one or more bulk liquid gas ISO containers at the customer's site.

In accordance with this invention, a method of UHP gas supply to large users is provided that results in dedicated UHP gas inventories for customers, involves directly supplying UHP liquid in ISO containers to the customers and maintaining storage volumes at the production site. This invention eliminates the need for gas transfill and tube trailers. The method of this invention is inherently more reliable from a customer's perspective.

The use of one or more ISO containers in accordance with this invention is beneficial for several reasons. For example, the ISO containers allow supplying of UHP gas at a wide range of flows, maintaining additional inventory at a customer site, and supplying UHP gas directly to the utilization site.

A bulk liquid ISO container can hold large amounts of UHP liquid or supercritical gas, for example, 1800-11000 gallons of UHP liquid gas. It is advantageous to supply UHP gas in liquid or supercritical form since larger quantities (over five times as many molecules) can be transported as an equal volume of UHP gaseous material. A larger volume of UHP gas source significantly reduces the frequency of change-outs, associated labor and risk of contamination. Also, implementing the supply method as described herein provides flexibility in UHP gas use rate and allows the customer to efficiently manage the inventory for long periods of time.

The UHP gas can be delivered to a variety of usage sites, for example, semiconductor manufacturing sites and other industrial application sites. When the usage site is a semiconductor manufacturing site, ultra-high purity gas can be used, for example, as a carrier gas for introducing an organometallic precursor into a chemical vapor or atomic layer deposition chamber. The ultra-high purity gas may also be used for dry etching in LCD processes. The ultra-high purity gas may further be used in backside cooling to control the rate and uniformity of etching processes of silicon layers. The ultra-high purity gas may also be used to check for leaks and line purges.

A monitoring system can be used to monitor the UHP gas storage tanks and the process variables feedback, i.e., temperature, pressure, and gas outlet flow rate. It can consist of a monitoring unit, e.g., telemetry, that gathers the process variables feedback. If upset conditions of any process variables feedback occur in the supply system or ISO container, the heating source may be adjusted in order to attempt to re-establish vessel pressure or temperature so that any change in product withdrawal rate is captured immediately, thus allowing for a fast response to fluctuations in customer demand.

The gas vaporization and supply system of this invention can utilize (i) one or more temperature measurement elements to provide feedback to the heating source controller, (ii) one or more pressure measurement elements to provide feedback to the heating source controller, and (iii) one or more gas output flow rate measurement elements to provide feedback to the heating source controller. The one or more temperature measurement elements can include thermocouple(s), the one or more pressure measurement elements can include pressure sensor(s), and the one or more gas output flow rate measurement elements can include flow rate gauge(s) or meter(s).

A control system and methodology can optionally be utilized in the operation of a UHP gas delivery system which is configured to enable automatic, real-time optimization and/or adjustment of operating parameters, i.e., process variables feedback, to achieve desired or optimal operating conditions. Suitable control means are known in the art and include, for example, a programmable logic controller (PLC) or a microprocessor.

A computer implemented system can optionally be used to control supply rates, heating and cooling of the ISO containers, settings on backpressure and relief valves, and the like. The computer control system can have the ability to adjust different parameters in an attempt to optimize delivery of UHP gas to the customer site. The system can be implemented to adjust parameters automatically. Control of the UHP gas delivery system can be achieved using conventional hardware or software-implemented computer and/or electronic control systems together with a variety of electronic sensors. The control system can be configured to control supply rates, heating and cooling of the ISO containers, settings on backpressure and relief valves, and the like.

The UHP gas delivery system can further comprise sensors for measuring a number of parameters such as supply rates, heating and cooling of the ISO containers, backpressure and relief valves, and the like. A control unit can be connected to the sensors and at least one of the inlet openings and outlet openings for conveying UHP gas throughout the system in accordance with the measured parameter values.

The computer implemented system can optionally be part of or coupled with the UHP gas delivery system. The system can be configured or programmed to control and adjust operational parameters of the system as well as analyze and calculate values. The computer implemented system can send and receive control signals to set and control operating parameters of the system. The computer implemented system can be remotely located with respect to the UHP gas delivery system. It can also be configured to receive data from one or more remote UHP gas delivery systems via indirect or direct means, such as through an ethernet connection or wireless connection. The control system can be operated remotely, such as through the Internet.

Part or all of the control of the UHP gas delivery system can be accomplished without a computer. Other types of control may be accomplished with physical controls. In an instance, a control system can be a manual system operated by a user. In another example, a user may provide input to a control system as described. A suitable pressure gauge may be used to monitor supply rates (for example, UHP gas delivery rates). The air pressure gauge can have a suitable shut-off valve that may be preset to shut off the supply of UHP gas to the customer if the rate exceeds a predetermined value.

The heating source controller is used to operate the gas vaporization and supply systems of this invention. As indicated above, the control strategy of this invention can react to any fluctuation to customer tool demand more sensitively. In accordance with this invention, the heating power is regulated using feedbacks from temperature, the vessel pressure, and/or the gas output flow rate measurement. Any changes in the gas output product flow rate will immediately impact the vessel pressure due to mass balance, and then will indirectly impact the temperature of the liquefied gas through vapor/liquid phase equilibrium and heat transfer, which is a slower process, especially for a large vessel such an ISO container. Therefore, by cascading pressure and/or flow rate control with temperature control in accordance with this invention, any change in product withdrawal rate is captured immediately and allows fast response to fluctuations in customer demand. Fast system response ensures uninterrupted operation of customer processes.

The heating source controller can involve using at least one of empirical data and one or more algorithms. The algorithms can determine adjusting process variables and/or time for adjusting the process variables, and then operating the heating source based on the algorithm. The algorithm determines the rate at which the process variables being supplied should vary and/or the time at which the rates should be varied based on the overall operation of the system. The algorithm chosen is based upon providing a desired operation of the system, in particular, a reliable and fast response to fluctuations in customer demand. The heating source controller can employ one of empirical data or one or more algorithms to determine the energy to be delivered to the liquefied gas in the vessel based on the measured pressure, temperature and gas output flow rate feedback.

The PID control scheme useful in this invention is named after its three correcting terms, whose sum constitutes the manipulated variable (MV). Hence:

MV(t)=Pₒᵤₜ+Iₒᵤₜ+Dₒᵤₜ

where Pₒᵤₜ, Iₒᵤₜ, and Dₒᵤₜ are the contributions to the output from the PID controller from each of the three terms as defined below.

The proportional term (sometimes called gain) makes a change to the output that is proportional to the current error value. The proportional response can be adjusted by multiplying the error by a constant Kₚ, called the proportional gain. The proportional term is given by:

Pₒᵤₜ=Kₚe(t)

where Pₒᵤₜ: Proportional term of output; Kₚ: Proportional gain, a tuning parameter; e: Error=SP−PV; and t: Time or instantaneous time (the present).

The integral term is given by:

$${I}_{out} = {K}_{i} {\int }_{0}^{t} e ( τ ) d τ$$

where Iₒᵤₜ: Integral term of output; Kᵢ: Integral gain, a tuning parameter; e: Error=SP−PV; t: Time or instantaneous time (the present); and τ: a dummy integration variable.

The derivative term is given by:

$${D}_{out} = {K}_{d} \frac{d}{d t} e ( t )$$

where Dₒᵤₜ: Derivative term of output; K_{d}: Derivative gain, a tuning parameter; e: Error=SP−PV; and t: Time or instantaneous time (the present).

A semi-empirical pressure-temperature algorithm can be useful in this disclosure. Heating power (PO) is a function of the temperature set point of the heaters (Tₛ), which is the main operating parameter.

PO=ƒ(Tₛ) (1)

Therefore, the first level of control is to regulate the temperature set point to achieve the desired heating power. Equation (1) can be either a linear or polynomial function.

The second level of control includes feedback from vessel pressure, and thus the relationship between Tₛ and the rate of supply pressure change needs to be established. Once there is a change in vapor withdrawal rate, the supply pressure will change and the rate of the pressure change (dp/dt) and the heater temperature set point before such change (Tₛ*) will dictate the new temperature set point (Tₛ*+ΔTₛ) required to maintain the supply pressure. ΔTₛ depends on the heel level (h) of the liquefied gas in the container. This relationship can be represented by

$$Δ {T}_{s} = {g}_{1} ( \frac{d p}{d t} , h , {T}_{s}^{*} ) \qquad ( 2 )$$

where g₁ is a function representing the dependence of ΔTₛ on the above described parameters, and h is the heel level. Equation (2) can be the product of individual linear or polynomial functions of dp/dt, h and Tₛ*. In a specific example, equation (2) is the product of individual linear functions of dp/dt, h and Tₛ*. In this case, equation (2) has the form

$$Δ {T}_{s} = {c}_{1} \frac{d p}{d t} h + {c}_{2} \frac{d p}{d t} + {c}_{3} h + {c}_{4} + {T}_{s}^{*}$$

where c₁, c₂, c₃ and c₄ are system-specific coefficients. In the design of the control system, such coefficients can be obtained through experimental data. dp/dt can be taken over a preset period of time (e.g., 1 minute) depending on the specific application, and such time period can be programmed during the design of the control system.

A feed forward flow-based control is useful in this disclosure. The third level of control also includes feedback from vapor withdrawal flow rate. According to energy balance, the desired heating power should be dynamically adjusted to balance the energy required to vaporize the product at any vapor product withdrawal rate fᵥ, i.e.,

PO=ƒᵥΔH (3)

where ΔH is the heat of vaporization of the liquefied gas, and fᵥ is the vapor product flow rate. The algorithm for adjusting heater temperature set points according to different product withdrawal rate can be obtained by combining equations (3) and (1).

ƒᵥ=ƒ(Tₛ)/ΔH (4)

where f(Tₛ) is the same function shown in equation (1). The following example illustrates the control system's reaction to one scenario of customer flow change. The system starts from a steady vapor product output (i.e., the energy input from the heater to the liquid product is equal to the energy needed to vaporize the liquid product at the steady flow rate) at a heater temperature set point Tₛ* and a system pressure set point of pₛ, and at time t=0 undergoes an increase in customer vapor product flow rate. After t=0, since the energy input from the heater is less than what is needed to vaporize the liquid product at the new flow rate, the pressure in the vessel will decrease, which can be detected by a pressure indicator. If hₜ₌₀ is the heel level at time t=0, which can be measured directly by either a liquid level indicator or indirectly by a scale, the adjustment of heater temperature set point ΔTₛ corresponding to the new vapor product flow rate can be calculated by equation (2). Meanwhile, the new product flow rate is also measured by a flow meter, and a new heater temperature set point is calculated using equation (4). Then the new heater temperature set point calculated from equation (4) is compared with the new heater temperature set point calculated from equation (2), i.e., Tₛ*+ΔTₛ, and the smaller value will be applied to the heater.

The control system can be configured to have the freedom to disengage lower level(s) of control, and the user can choose to engage only the first level (temperature) or the first two levels (temperature and pressure) of control. Such simplified versions of control may be desirable during system tuning or maintenance, or when customer's demand pattern does not include large variations that can justify adding a third level of control. If only the first level of control is engaged, the user can manually set the temperature set points for the heater temperatures and/or the vessel surface temperatures according to the customer gas demand and known relationship between the gas flow rates and the temperature set points (e.g., equation (1)). However, with any dynamic change in customer gas demand, the temperature set points need to be manually adjusted. If only the first two levels of control are engaged, the user can manually set the pressure set points according to the required supply pressure of the gas and the pressure loss during gas transport downstream of the vessel.

Other forms of algorithms can also be useful in this disclosure taking into account of vessel type, heater type, and the like. The above algorithms used in the three levels of control (equations (1), (2) and (4)) may have different forms depending on factors such as vessel type and ambient temperatures. For example, equation (2) above relates temperature set point to the vessel pressure and heel level, which is generally applicable to all vessel types. However, if for certain vessels the effect of the heel level on the temperature set point—pressure relationship is negligible, equation (2) can be simplified by removing heel level from the variable set. Other factors such as the ambient temperature may also affect the form of the algorithms. For example, equation (1) above does not include the ambient temperature as one of the variables, but if the system is subject to large variations in ambient temperature (e.g., outdoor installation), adding the ambient temperature into the variable set may be necessary.

In equation (2), the heel level variable can be easily replaced by the product weight, which can be measured by a scale under the vessel. The relationship between the product weight and heel level can be defined from the geometry and dimension of the vessels.

This invention affords improved system reliability leading to fewer shutdowns of the customer processes and fewer heater change outs, e.g., fewer heater burnouts. This invention provides the minimal power required during dynamic changes in customer demand. This reduces the process costs for customers by reducing the possibility for system shutdown due to insufficient vapor product supply.

Various modifications and variations of this invention will be obvious to a worker skilled in the art and it is to be understood that such modifications and variations are to be included within the purview of this application and the spirit and scope of the claims.

### Example 1

Referring to FIG. 1, this example illustrates a two-level cascade control system that dynamically adjusts heating power to a vessel in response to customer flow rate change. In this two-level cascade control system, only the pressure indicating controller (PIC) and the temperature indicating controller (TIC) are engaged. At a given time=0 seconds, the vessel is warmed up and the vessel pressure is stabilized at the PIC set point, for example, 120 psig. The vapor flow to the customer usage site is zero (i.e., the BSGS is idle). The moment the customer starts to draw vapor flow (e.g., time=0 seconds), the vessel pressure decreases immediately, for example, to 119 psig. The PIC calculates an output signal based on the difference between the vessel pressure and the PIC set point of −1 psig at that moment. The output signal from the PIC corresponds to a change in the temperature set point of the TIC, in this case, for example, +10° F. (i.e., the TIC set point is to be increased by 10° F.). The TIC then increases the heating power to meet the new temperature set point. Once the increased heating power starts making up for the increased vapor flow, the vessel pressure will increase and approach the PIC set point, at which point the cascade control system will again adjust the heating power based on updated vessel pressure.

### Example 2

Referring to FIG. 1, this example illustrates a three-level cascade control system that dynamically adjusts heating power to a vessel in response to customer flow rate change. In this three-level cascade control system, the pressure indicating controller (PIC), the temperature indicating controller (TIC) and the flow indicating controller (FIC) are all engaged. At a given time=0 seconds, the vessel is warmed up and the vessel pressure is stabilized at the PIC set point, for example, 120 psig. The vapor flow to the customer usage site is stabilized at the FIC set point, for example, 100 standard liters per minute (slpm). The moment the customer starts to draw vapor flow of, for example, 110 slpm (e.g., time=0 seconds), the vessel pressure decreases immediately, for example, to 119 psig. The PIC calculates an output signal based on the difference between the vessel pressure and the PIC set point of −1 psig at that moment. The FIC also calculates an output signal based on the difference between the customer vapor flow rate and the FIC set point of +10 slpm.

The output signal from the PIC corresponds to a change in the temperature set point of the TIC, in this case, for example, +10° F. (i.e., the TIC set point is to be increased by 10° F.). The output signal from the FIC corresponds to a change in the temperature set point of the TIC, in this case, for example, +12° F. (i.e., the TIC set point is to be increased by 12° F.). The output signals from the PIC and the FIC are compared, and the lower value signal (i.e., +10° F.) is used to dictate the TIC. The TIC then increases the heating power to meet the new temperature set point. Once the increased heating power starts making up for the increased vapor flow, the vessel pressure will increase and approach the PIC set point, at which point the cascade control system will again adjust the heating power based on the updated vessel pressure or customer vapor flow rate.

1. A gas vaporization and supply system comprising:
(a) a vessel suitable for holding a bulk quantity of a liquefied gas;
(b) at least one heating source positioned on or near the vessel to supply energy to, or remove energy from, the liquefied gas; and
(c) a heating source controller adapted to use process variables feedback for dynamically regulating said heating source and maintaining and regulating gas output, said process variables feedback resulting from cascading sequence control of at least two process variables.

2. The gas vaporization and supply system of claim 1 wherein said at least two process variables comprise pressure and temperature.

3. The gas vaporization and supply system of claim 1 wherein said at least two process variables comprise pressure, temperature and gas output flow rate.

4. The gas vaporization and supply system of claim 1 wherein said heating source controller further employs at least one of empirical data and one or more algorithms to determine the energy to be delivered to the liquefied gas in the vessel based on the measured pressure, temperature and optionally gas output flow rate feedback.

5. The gas vaporization and supply system of claim 1 further comprising a pressure indicating controller and a gas output flow rate controller.

6. The gas vaporization and supply system of claim 5 wherein the heating source controller, pressure indicating controller and gas output flow rate controller comprise proportional-integral-derivative (PID) controllers.

7. The gas vaporization and supply system of claim 1 wherein said gas vaporization and supply system utilizes (i) one or more temperature measurement elements to provide feedback to said heating source controller, (ii) one or more pressure measurement elements to provide feedback to said heating source controller, and optionally (iii) one or more gas output flow rate measurement elements to provide feedback to said heating source controller.

8. The gas vaporization and supply system of claim 7 wherein (i) said one or more temperature measurement elements comprise thermocouple(s), (ii) said one or more pressure measurement elements comprise pressure sensor(s), and (iii) said one or more gas output flow rate measurement elements comprise flow rate gauge(s) or meter(s).

9. The gas vaporization and supply system of claim 1 wherein said heating source is selected from a plurality of heating elements positioned on the vessel to supply energy into the liquefied gas; a ceramic heater positioned on or near the vessel to supply energy into the liquefied gas; a heating jacket positioned on the vessel to supply energy into the liquefied gas; or a heat exchanger positioned on or near the vessel to supply energy to or remove energy from the liquefied gas.

10. The gas vaporization and supply system of claim 1 wherein said heating source controller is a programmable logic controller or a microprocessor.

11. The gas vaporization and supply system of claim 9 wherein said plurality of heating elements are divided into a plurality of heating zones, each heating zone having at least one heating element.

12. The gas vaporization and supply system of claim 10 wherein said programmable logic controller staggers activation of said heating elements.

13. The gas vaporization and supply system of claim 1 wherein said vessel is a bulk container selected from an ISO container, a tube trailer, a tanker, a ton container, a drum, and a container having a water capacity of at least about 450 liters.

14. The gas vaporization and supply system of claim 1 further comprising a conduit having a first end connected to said vessel and a second end disposed to deliver said liquefied gas, substantially in gaseous form, to a usage site.

15. The gas vaporization and supply system of claim 1 wherein said liquefied gas is an ultra high purity gas.

16. The gas vaporization and supply system of claim 1 wherein said liquefied gas is selected from ammonia, hydrogen chloride, hydrogen bromine, chlorine and perfluoropropane.

17. A method for delivery of a gas from a liquefied state in a controlled manner to a usage site, said method comprising:
(i) providing a vessel holding a bulk quantity of a liquefied gas therein;
(ii) providing at least one heating source positioned on or near the vessel to supply energy to, or remove energy from, the liquefied gas;
(iii) providing a heating source controller adapted to use process variables feedback for dynamically regulating said heating source and maintaining and regulating gas output, said process variables feedback resulting from cascading sequence control of at least two process variables;
(iv) controlling flow of said gas out of said vessel by said heating source controller utilizing said process variables feedback to regulate said heating source; and
(v) delivering said gas to said usage site.

18. The method of claim 17 wherein said at least two process variables comprise pressure and temperature.

19. The method of claim 17 wherein said at least two process variables comprise pressure, temperature and gas output flow rate.

20. The method of claim 17 wherein said heating source controller is a programmable logic controller or a microprocessor.

21. The method of claim 17 further providing a pressure indicating controller and a gas output flow rate controller.

22. The method of claim 21 wherein the heating source controller, pressure indicating controller and gas output flow rate controller comprise proportional-integral-derivative (PID) controllers.

23. The method of claim 17 wherein said controlling is based on at least one of empirical data and one or more algorithms.

24. The method of claim 17 wherein said usage site is a semiconductor manufacturing site.

25. The method of claim 17 wherein said liquefied gas is an ultra high purity gas.

26. The method of claim 17 further comprising passing said ultra-high purity gas through a filtration apparatus prior to delivering said ultra-high purity gas to said usage site.

27. The method of claim 17 wherein said vessel is a bulk container selected from an ISO container, a tube trailer, a tanker, a ton container, a drum, and a container having a water capacity of at least about 450 liters.

28. The method of claim 17 wherein said liquefied gas is selected from ammonia, hydrogen chloride, hydrogen bromine, chlorine and perfluoropropane.
